(19) United States
(12) Patent Application Publication
(10) Pub. No.: US 2026/0196201 A1
(43) Pub. Date: Jul. 9, 2026

(54) BROADBAND METAMATERIAL SILENCER FOR VENTILATION DUCT, AND DESIGN METHOD AND APPLICATION THEREOF

(71) Applicant: ACOUSTIC METAMATERIALS COMPANY LIMITED, Hong Kong (CN)

(72) Inventors: Min YANG, Hong Kong (CN); Shuyu CHEN, Hong Kong (CN); Songwen XIAO, Hong Kong (CN); Mengyao XIE, Hong Kong (CN); Yunfei XU, Hong Kong (CN); Xiaonan ZHANG, Hong Kong (CN)

(21) Appl. No.: 19/133,889

(22) PCT Filed: Dec. 8, 2022
(86) PCT No.: PCT/CN2022/137550

§ 371 Date: May 29, 2025

(30) Foreign Application Priority Data
Dec. 1, 2022 (CN) 202211530864.5

(51) Int. Cl. G10K 11/168; F24F 13/02; F24F 13/24; G10K 11/16; G10K 11/172

(52) U.S. Cl. CPC G10K 11/168; F24F 13/02; F24F 13/24; G10K 11/161; G10K 11/172; F24F 2013/242; F24F 2013/245

(57) ABSTRACT

The present invention provides a broadband metamaterial silencer for a ventilation duct. The broadband metamaterial silencer for the ventilation duct according to the present invention is a duct-outside broadband metamaterial silencer, or a duct-inside shunted broadband metamaterial silencer, or a broadband metamaterial degenerate sound absorber. Moreover, the present invention further provides a design method for the broadband metamaterial silencer for the ventilation duct, and application thereof in a wearable device, indoor and outdoor heating, ventilation, and air conditioning (HVAC) devices, and household appliances. The broadband metamaterial silencer of the present invention can efficiently achieve noise reduction for broadband noise in ducts.

### FIELD OF THE INVENTION

The present invention relates to the technical field of noise treatment, and in particular relates to a broadband metamaterial silencer, and a design method and application thereof.

### THE PRIOR ARTS

In daily life and industrial production, heat and material accumulation often occur due to various reasons. For example, heat may generate inside chips and machines, which operate at a high power, dust may accumulate during operations in factories, and water vapor may retain in wearable devices due to human respiration and perspiration. Thus, it is crucial to carry away excessive heat and materials through airflow.

It is a common solution to realize ventilation through a duct, and the solution has the advantages of high efficiency, simple design, etc. Through drawing and/or discharging by a fan system, air or other gases from a target space may carry heat and accumulated substance to enter a duct system and then may be guided out along a designed pathway.

The airflow in ducts is often accompanied by noise problems. Such noise often comes from two sources. The first source is inherent mechanical noise of devices or other internal ambient noise; and the second source is noise additionally generated by the fan system. The two types of noise have the characteristics of broad frequency bands and obvious characteristic frequencies (for example, noise generated by a fan has characteristic frequencies corresponding to the rotational speed of the fan). Such characteristics pose significant challenges to conventional noise-reduction technologies. Traditional porous acoustic materials, such as sponge, rockwool and fiberglass, provide a broad operating frequency band, but cannot be customized for characteristic noise frequency bands to enhance absorption. Traditional acoustic resonance technologies, such as a technology using Helmholtz resonators, allow precise customization of operating frequencies but provide a very narrow bandwidth. Thus, how to simultaneously ensure broadband acoustic effects and frequency-specific customization capabilities in ventilated environments has become an urgent challenge.

### SUMMARY OF THE INVENTION

In response to the problems in the existing broadband noise-reduction technology for a ventilation duct, the present invention aims to provide a broadband metamaterial silencer for a ventilation duct, and a design method and application thereof.

In general, a primary function of the duct is to guide airflow to circulate, such that it is desirable that silencing and noise-reduction operations do not impede the duct too much. An optimal method for achieving this requirement is to mount sound insulating/absorbing materials on side walls. For a given target broadband impedance, a plurality of resonance units can be designed accordingly to realize acoustic properties.

Thus, the present invention uses a technical solution of providing a broadband metamaterial silencer for a ventilation duct, wherein the broadband metamaterial silencer is a duct-outside broadband metamaterial silencer, or a duct-inside shunted broadband metamaterial silencer, or a broadband metamaterial degenerate sound absorber;

Wherein:

The duct-outside broadband metamaterial silencer includes a broadband sound insulator arranged outside the duct, a broadband sound absorber arranged outside the duct, or a combination of the broadband sound insulator arranged outside the duct and the broadband sound absorber arranged outside the duct.

The duct-inside silencer includes a broadband sound insulator arranged inside the duct, a broadband sound absorber arranged inside the duct, or a combination of the broadband sound insulator arranged inside the duct and the broadband sound absorber arranged inside the duct; and

The broadband metamaterial degenerate sound absorber includes a plurality of perforated acoustic plates that are perpendicular to an airflow direction in the duct, and the duct-outside broadband metamaterial silencer, or the duct-inside shunted broadband metamaterial silencer, or a combination of the duct-outside broadband metamaterial silencer and the duct-inside shunted broadband metamaterial silencer.

Further, for the broadband metamaterial silencer for the ventilation duct, the broadband sound insulator arranged outside the duct consists of a plurality of resonance units that are arranged in parallel and mutually independent, resonance behaviors of each resonance unit are single-frequency resonance behaviors and correspond to a specific frequency band of broadband noise to be reduced, and the resonance units achieve a sound insulating effect by reflecting sound waves at resonance frequencies and frequencies adjacent thereto; each resonance unit is arranged on a side wall of the ventilation duct and provided with an opening on the duct wall of the ventilation duct, or, each resonance unit is arranged on a side wall of the ventilation duct and provided with an opening on the duct wall of the ventilation duct, wherein a mesh covering material is provided at the opening of each resonance unit;

The broadband sound absorber arranged outside the duct consists of a plurality of resonance units that are arranged in parallel and mutually independent, resonance behaviors of each resonance unit are single-frequency resonance behaviors and correspond to a specific frequency band of broadband noise to be reduced, and the resonance units achieve a sound absorbing effect by converting noise energy into heat energy and dissipating the heat energy; each resonance unit is arranged on the side wall of the ventilation duct and provided with an opening on the duct wall of the ventilation duct, or, each resonance unit is arranged on the side wall of the ventilation duct and provided with an opening on the duct wall of the ventilation duct, wherein a mesh covering material is provided at the opening of each resonance unit;

The broadband sound insulator arranged inside the duct consists of a plurality of resonance units that are arranged in parallel and mutually independent, resonance behaviors of each resonance unit are single-frequency resonance behaviors and correspond to a specific frequency band of broadband noise to be reduced, and the resonance units achieve a sound insulating effect by reflecting sound waves at resonance frequencies and frequencies adjacent thereto; each resonance unit is arranged inside the ventilation duct and provided with an opening inside the ventilation duct, or, each resonance unit is arranged inside the ventilation duct and provided with an opening inside the ventilation duct, wherein a mesh covering material is provided at the opening of each resonance unit;

The broadband sound absorber arranged inside the duct consists of a plurality of resonance units that are arranged in parallel and mutually independent, resonance behaviors of each resonance unit are single-frequency resonance behaviors and correspond to a specific frequency band of broadband noise to be reduced, and the resonance units achieve a sound absorbing effect by converting noise energy into heat energy and dissipating the heat energy; each resonance unit is arranged inside the ventilation duct and provided with an opening inside the ventilation duct, or, each resonance unit is arranged inside the ventilation duct and provided with an opening inside the ventilation duct, wherein a mesh covering material is provided at the opening of each resonance unit; and

For the broadband metamaterial degenerate sound absorber, each perforated acoustic plate and the duct-outside broadband metamaterial silencer and/or the duct-inside shunted broadband metamaterial silencer correspond to a specific frequency band of the broadband noise to be reduced.

Further, for the broadband metamaterial silencer for the ventilation duct, each resonance unit includes a rigid housing with an opening and the air in the cavity of the rigid housing.

Further, for the broadband metamaterial silencer for the ventilation duct, each resonance unit includes, but is not limited to, Fabry-Perot resonators (quarter-wavelength), Helmholtz resonators, and resonators with cavities that are in an arbitrary shape, which can isolate or absorb noise at a specific frequency band.

Further, for the broadband metamaterial silencer for the ventilation duct, the plurality of resonance units are arranged into geometric shapes with cavities of identical or different cross-sections, and each cavity is bent and folded on a certain plane, or on a curved surface, or in a three-dimensional space.

Further, for the broadband metamaterial silencer for the ventilation duct, the perforated acoustic plates are used for filtering impurities in the air in the ventilation duct.

Further, for the broadband metamaterial silencer for the ventilation duct, the mesh covering material includes, but is not limited to, a metal mesh, sponge, woven fabric, a paper-based material, fiberglass cloth, perforated acoustic plates, and any combination of the above six materials.

Further, for the broadband metamaterial silencer for the ventilation duct, the materials of the broadband metamaterial silencer include, but are not limited to, metal, plastic, wood, leather, a paper-based material, ceramic, and any combination of the above six materials.

Further, for the broadband metamaterial silencer for the ventilation duct, the ventilation duct is in an arbitrary shape, including a straight-through shape, a bent shape, and constant or variable cross-sectional shapes.

The frequency band in which the broadband metamaterial silencer takes effect, and effects thereof are customizable. Because the operating frequency of each resonance unit can be freely adjusted through design of geometric shape, while frequency distribution ωₘ of broadband resonators can also be realized by designing a plurality of resonance units with different frequencies. In principle, the impedance of any spectral profile can be realized by a series of resonance units. However, in fact, a wider effective frequency band range and better sound insulating performance both imply the need for a larger volume to design the resonators. On the other hand, many noise spectra encountered in real life often exhibit strong frequency characteristics. Therefore, designing broadband noise-reduction metamaterials with customizable spectra according to the characteristics of specific noise spectra is the most space-efficient and cost-effective solution.

Based on this, the present invention uses a second technical solution of providing a design method for a broadband metamaterial silencer for a ventilation duct, the method including the following steps:
1) Acquiring internal structural data of the ventilation duct, gas flow velocity data and gas flow rate data, as well as spectral data of noise to be reduced, containing noise intensity information;
2) According to the data acquired in step 1), optimizing the internal structure of the ventilation duct to reduce the intensity of the noise to be reduced, and then reacquiring the gas flow velocity data and the gas flow rate data, and the processed spectral data of the noise to be reduced;
3) According to the processed spectral data of the noise to be reduced and an upper limit of a design volume for the broadband metamaterial silencer, setting a target broadband impedance that maximizes reduction in the intensity of noise within a target frequency band in the ventilation duct, and then selecting a type of the broadband metamaterial silencer, as well as M resonance units or K perforated acoustic plates and L resonance units in the broadband metamaterial silencer, such that an acoustic impedance spectral profile of the M resonance units or the K perforated acoustic plates and the L resonance units is the same as that of the target broadband impedance;
Specifically,
3.1) When the broadband metamaterial silencer is a duct-outside broadband metamaterial silencer, or a duct-inside shunted broadband metamaterial silencer;
3.1.1) Fabry-Perot resonators serve as the resonance units:

For a given target broadband impedance, in order to realize the acoustic impedance spectral profile Z(ω) as a function of an angular frequency ω, designing M Fabry-Perot resonators with the same cross-sectional area; arranging the resonators in order from the longest to the shortest, and denoting the length of the m^{th} resonator as Lₘ, with a corresponding first-order resonance frequency being ωₘ=λc/(2Lₘ); according to the frequency distribution ωₘ, obtaining the number of modes Ma per unit frequency; then adjusting the length Lₘ of each resonator, such that the frequency distribution om meets the acoustic impedance spectral profile Z(ω);

Wherein a constraint therein may be expressed by the following equation (1):

$$\frac{ρ c}{2 ω} R e ( \frac{1}{Z ( ω )} ) = {\sum }_{q = 0}^{∞} \frac{\overline{{M}_{d}} [ ω / ( 2 q + 1 ) ]}{{( 2 q + 1 )}^{2}} \qquad ( 1 )$$

Wherein M̅_̅{̅d̅}̅=M_{d}φ/M, φ is the ratio of the area of openings of all resonators to the total area of sound wave incident surfaces, ρ=1.2 kg/m³ represents the air density, c=343 m/s represents the speed of sound waves in air, ω is the angular frequency (in Hz), and q is an integer greater than or equal to zero;
The Fabry-Perot resonators of different lengths are folded as needed to form a compact whole for space saving, with either regular or specific geometric features;
3.1.2) Helmholtz resonators serve as the resonance units:

Denoting the area of the opening of the m^{th} resonator as aₘ, the length of the opening as [symbol] , the cross-sectional area of the cavity as Aₘ, and the length of the cavity as L, such that the resonance frequency of the m^{th} Helmholtz resonator is

$${ω}_{m} = c \sqrt{\frac{{a}_{m}}{{A}_{m} L ℓ}} ;$$

selecting aₘ/Aₘ, such that ωₘ is uniformly distributed across the frequency range; on a premise that the value of aₘ/Aₘ is maintained unchanged, adjusting Aₘ, such that impedances Zₘ of different resonators can be superposed to obtain the acoustic impedance spectral profile Z(ω):
Wherein a constraint equation (2) is:

$$\frac{1}{Z ( ω )} = {\int }_{Δ f} \frac{M / Δ f}{{Z}_{m} ( {ω}_{m} )} d {ω}_{m} \qquad ( 2 )$$

Wherein Z(ω) is in kg·m⁻²·s⁻¹;
Zₘ=i(ωₘ²−ω²)/(ωfₘ), Zₘ is in kg·m⁻²·s⁻¹; fₘ represents the resonance intensity, which is proportional to Aₘ, in m²/kg; ωₘ is in Hz; ω represents the angular frequency, in Hz;
Δf represents the target frequency band, in Hz;
M represents the total number of the Helmholtz resonators;
3.2) When the broadband metamaterial silencer is a broadband metamaterial degenerate sound absorber:
3.2.1) Design of the perforated acoustic plates

For a rigid perforated plate with a thickness of τ (in m), if circular holes therein have a hole diameter of d (in m) and a porosity of φ, corresponding dipole acoustic impedance Za is shown as equation (3):

$${Z}_{d} = - i ω {\frac{ρ τ}{2 ϕ} [ 1 - \frac{2}{σ \sqrt{i}} \frac{{J}_{1} ( σ \sqrt{i} )}{{J}_{0} ( σ \sqrt{i} )} ]}^{- 1} - i 0.85 ω \frac{ρ d}{2 ϕ} \qquad ( 3 )$$

Wherein σ=d\sqrt{ω/4ν}, ω is the broadband resonance frequency (in Hz), ρ=1.2 kg/m³ is air density, ν is kinematic viscosity of air (in m²/s), i is the imaginary unit, and J_{0/1} is the zero-order (first-order) Bessel function;
The above equation has an asymptotic expansion equation (4):

$${Z}_{d} = 16 v ρ \frac{τ}{{d}^{2} ϕ} - i \frac{51 d + 80 τ}{120 ϕ} ρω + … \qquad ( 4 )$$

When the frequency is not too high and the hole diameter and the thickness of the plate are not too large, the second term and other higher-order terms in equation (4) can be neglected, such that the acoustic impedance of the perforated plates can be approximated as a frequency-independent constant;
By designing three geometric parameters of the perforated plates, 16νρτ/(d²φ) is made to match the acoustic impedance spectral profile Z(ω);
3.2.2) Design of a broadband sound insulator, or a broadband sound absorber, or a combination of the broadband sound insulator and the broadband sound absorber

According to the method in step 3.1), obtaining the broadband sound insulator, or the broadband sound absorber, or the combination of the broadband sound insulator and the broadband sound absorber, of which the noise-reduction frequency distribution range is not greater than that of the perforated acoustic plates in step 3.2.1);
3.2.3) After the two acoustic structures are combined, obtaining the desired broadband metamaterial degenerate sound absorber; and
4) According to the broadband metamaterial silencer designed in step 3) and the acoustic impedance spectral profile thereof, optimizing an inner wall of the duct, a structure of the broadband metamaterial silencer, and a material and/or structure of a mesh covering material again to remove noise at a target frequency.

Further, for the design method for the broadband metamaterial silencer for the ventilation duct, in step 3), the method for selecting the type of the broadband metamaterial silencer includes:
Wherein the type of the broadband metamaterial silencer is the broadband sound insulator, the broadband sound absorber and the broadband metamaterial degenerate sound absorber;

### Step I:

When reflected energy of broadband noise generates adverse effects on the environment and devices at an air inlet end of the ventilation duct, or when the reflected energy may be reflected back into the duct again, selecting the broadband sound absorber or the broadband metamaterial degenerate sound absorber; otherwise, determining all three types of absorbers are applicable;

### Step II:

When the overall dimension of the broadband metamaterial silencer in the propagation direction of sound waves is smaller than the upper limit of the wavelength of the sound waves of noise within the target frequency band, selecting the broadband sound insulator, or the broadband metamaterial degenerate sound absorber, or the combination of the broadband sound absorber and the broadband sound insulator; otherwise, determining all three types of absorbers are applicable; and

### Step III:

When the broadband metamaterial silencer is sensitive to the influence of airflow, selecting the broadband sound insulator, or the broadband sound absorber, or the combination of the broadband sound absorber and the broadband sound insulator; otherwise, determining all three types of absorbers are applicable.

Based on the structure of the broadband metamaterial and the design method for the broadband metamaterial, the present invention uses a third technical solution of providing practical application of the broadband metamaterial silencer to a broadband noise-reduction scenario for the ventilation duct.

The first application of the metamaterial provided in the present invention is:
Application of a broadband metamaterial silencer for a ventilation duct, wherein the broadband metamaterial silencer is used for noise reduction of a wearable device, wherein
The material of the wearable device is designed to be an outwardly protruding rigid material including two or more layers, a plurality of sealed cavities are provided between adjacent rigid material layers, and a sealed inner cavity is formed between the innermost rigid material layer or a portion thereof and the skin of the wearer; the inner cavity is in communication with other sealed cavities through channels in the rigid material layers, such that the inner cavity and the other cavities jointly form the ventilation duct, an inlet of the ventilation duct is formed in the innermost rigid material layer or an outermost rigid material layer, and an outlet of the ventilation duct is formed in the innermost rigid material layer or the outermost rigid material layer; and the broadband metamaterial silencer is a broadband metamaterial degenerate sound absorber.

Further, for the application of the broadband metamaterial silencer for the ventilation duct, wherein the material of the wearable device is designed to be an outwardly protruding rigid material including two layers, which are the innermost rigid material layer and the outermost rigid material layer, two sealed cavities defined as the first cavity and the third cavity are provided between the two rigid material layers, and a sealing cushion that is in contact with the skin of the wearer is provided on an inner wall of the innermost rigid material layer, such that the inner cavity is formed between a portion of the innermost rigid material layer and the skin of the wearer, and the inner cavity is defined as the second cavity; the first channel and the second channel are provided on the innermost rigid material layer of the inner cavity; the first cavity is in communication with the second cavity through the first channel, and the second cavity is in communication with the third cavity through the second channel, such that the inner cavity, the first cavity and the third cavity jointly form the ventilation duct, the inlet of the ventilation duct is provided in the innermost rigid material layer of the first cavity and located outside the inner cavity, and the outlet of the ventilation duct is provided in the innermost rigid material layer of the third cavity and located outside the inner cavity; and the broadband metamaterial silencer is the broadband metamaterial degenerate sound absorber, and consists of perforated acoustic plates and a broadband sound absorber arranged outside the duct, wherein the perforated acoustic plates are arranged at the first channel and the second channel, while the broadband sound absorber arranged outside the duct is arranged on side walls of the first cavity and the third cavity, respectively.

Further, for the application of the broadband metamaterial silencer for the ventilation duct, a fan is provided at the inlet and/or the outlet of the ventilation duct.

Further, for the application of the broadband metamaterial silencer for the ventilation duct, the frequency range of noise reduced by the broadband metamaterial degenerate sound absorber is 800 Hz to 8000 Hz.

Further, for the application of the broadband metamaterial silencer for the ventilation duct, the resonance units of the broadband sound absorber arranged outside the duct are Helmholtz resonators, and cavities of the Helmholtz resonators are reciprocatingly folded into a labyrinthine shape; and the plurality of Helmholtz resonators are provided, some of the Helmholtz resonators are provided with openings on the side wall of the first cavity, and other Helmholtz resonators are provided with openings on the side wall of the third cavity.

The second application of the metamaterial provided in the present invention is:
Application of a broadband metamaterial silencer for a ventilation duct, wherein the broadband metamaterial silencer is used for noise reduction in the ventilation duct of an indoor air exchange device;
A broadband sound absorber arranged outside the duct is mounted on a side wall of the ventilation duct at an air outlet of the indoor air exchange device, resonance units of the broadband sound absorber are Fabry-Perot resonators, cavities of the resonance units are reciprocatingly folded on a same plane, the plurality of resonance units that are arranged in parallel and mutually independent form a noise-reduction layer sleeved outside the ventilation duct, each resonance unit in the noise-reduction layer is provided with an opening on the side wall of the ventilation duct, and the plurality of noise-reduction layers are stacked to form the broadband sound absorber; and
The frequency range of noise reduced by the broadband sound absorber is 200 Hz to 8000 Hz.

The third application of the metamaterial provided in the present invention is:
Application of a broadband metamaterial silencer for a ventilation duct, wherein the broadband metamaterial silencer is used for noise reduction in a ventilation duct of an outdoor heating, ventilation, and air conditioning (HVAC) device;
A broadband sound absorber arranged inside the duct is mounted inside the ventilation duct of the outdoor HVAC device, resonance units of the broadband sound absorber are Fabry-Perot resonators, cavities of the resonance units are reciprocatingly folded on the same plane, the plurality of resonance units that are arranged in parallel and mutually independent form the broadband sound absorber which is rectangular, V-shaped, concave-convex, louver-shaped, array-shaped, etc., and each resonance unit is provided with an opening in the ventilation duct; and
The frequency range of noise reduced by the broadband sound absorber is 200 Hz to 8000 Hz.

The fourth application of the metamaterial provided in the present invention is:
Application of a broadband metamaterial silencer for a ventilation duct, wherein the broadband metamaterial silencer is used for noise reduction in a ventilation duct of a gas water heater, wherein
A broadband sound insulator arranged outside the duct is mounted on a side wall of the ventilation duct at an air inlet of a centrifugal fan of the gas water heater, resonance units of the broadband sound insulator are Fabry-Perot resonators, cavities of the resonance units are reciprocatingly folded on a same plane, the plurality of resonance units that are arranged in parallel and mutually independent form the broadband sound insulator sleeved outside the duct, and each resonance unit is provided with an opening on the side wall of the ventilation duct; and
The frequency range of noise reduced by the broadband sound insulator is 200 Hz to 4000 Hz.

The fifth application of the metamaterial provided in the present invention is:
Application of a broadband metamaterial silencer for a ventilation duct, wherein the broadband metamaterial silencer is used for noise reduction in a ventilation duct of a device power component (including, but not limited to a pump, a compressor, a motor, etc.);
A broadband sound insulator arranged outside the duct is mounted on a side wall of the ventilation duct at an outlet and/or inlet of the ventilation duct of a compartment of the device power component, resonance units of the broadband sound insulator are Fabry-Perot resonators, cavities of the resonance units are reciprocatingly folded on a same plane, the plurality of resonance units that are arranged in parallel and mutually independent form the broadband sound insulator sleeved outside the duct, and each resonance unit is provided with an opening on the side wall of the ventilation duct; and
The frequency range of noise reduced by the broadband sound insulator is 160 Hz to 4000 Hz.
   Compared with the prior art, the present invention has the advantages that
1. The broadband metamaterial silencer of the present invention is the duct-outside broadband metamaterial silencer, or the duct-inside shunted broadband metamaterial silencer, or the broadband metamaterial degenerate sound absorber, thereby efficiently realizing noise-reduction effect on the broadband noise of the duct; and
2. When being used in a wearable device, the broadband metamaterial silencer of the present invention has greater advantages compared with other conventional techniques. The wearable device is in close contact with a human body, and thus, it is an essential requirement for the wearable device to have breathability and ventilation. But the properties of breathability and ventilation and good noise reduction/sound insulation are inherently contradictory by nature. To reduce noise in heat dissipation components such as fans in devices or prevent external noise from influencing signal acquisition in internal devices, the ventilation and noise-reduction properties of the broadband metamaterial silencer have great advantages. On the other hand, lightness is critically important for the wearable devices as well. Customizable characteristics of the broadband metamaterial silencer technology can achieve maximum acoustic performance with minimal space and least materials, thereby effectively controlling the overall weight of the device. Finally, because the broadband metamaterial silencer is made of materials such as plastic and silicone without traditional porous acoustic materials, the structure and the material of the broadband metamaterial silencer can effectively prevent water vapor generated due to human respiration and perspiration and foreign matter from being absorbed, and the broadband metamaterial silencer is easily detachable for direct cleaning. The property can enable the requirement for hygiene of the wearable device to be well met.
3. When being applied in the fields of indoor and outdoor HVAC devices, the broadband metamaterial silencer of the present invention has the following advantages. Firstly, the function of the broadband metamaterial silencer is based on structural design and the broadband metamaterial silencer does not contain traditional fibrous porous materials, such that the broadband metamaterial silencer has no potential harm to human health. Secondly, there are no problems such as water accumulation and mould generation in the internal structure of the broadband metamaterial silencer, such that the broadband metamaterial silencer has a long service life and may be used in high-standard environments such as clean rooms and dust-free rooms. In addition, in response to different noise properties of different devices, the operating frequency spectrum of the broadband metamaterial silencer is customizable, the sound absorption or insulation ability is centralized in primary noise frequency bands, thereby more efficiently reducing the overall noise. For special scenarios requiring requirements for high-temperature resistance, the resonance units of the silencer can be made of pure metal materials to meet corresponding requirements.
4. When being applied in household appliances, the broadband metamaterial silencer of the present invention has the following advantages. Firstly, by combining the structural design with a narrow available space inside the household appliances and performing targeted customization on frequency bands of primary noise energy, effective noise reduction starting from 200 Hz can be achieved within a limited space of a few centimeters. Thus, the noise of the device can be reduced most efficiently without affecting other performances. In addition, the resonance units of the silencer can be made of the same material as an internal connection position, so as to maintain the integrity of an original structure in appearance.

### BRIEF DESCRIPTION OF THE DRAWINGS

FIG. 1 is a schematic section view of a duct-inside shunted broadband metamaterial silencer, which forms a straight-through air duct inside the duct;

FIG. 2 is a schematic section view of a duct-inside shunted broadband metamaterial silencer, which forms a V-shaped air duct inside the duct;

FIG. 3 is a schematic section view of a duct-inside shunted broadband metamaterial silencer, which forms a concave-convex air duct inside the duct;

FIG. 4 is a schematic section view of a duct-outside broadband metamaterial silencer, with a mesh covering material at an opening of each resonance unit;

FIG. 5 is a schematic section view of a broadband metamaterial degenerate sound absorber;

FIG. 6 is a curve diagram showing noise absorption efficiency of the broadband metamaterial degenerate sound absorber shown in FIG. 5;

FIG. 7 is a perspective schematic view of a broadband sound insulator or a broadband sound absorber where cavities of a plurality of resonance units with different cross sections are arranged into a cuboid, and each cavity is reciprocatingly folded in an L shape on a plane;

FIG. 8 is a perspective schematic view of a broadband sound insulator or a broadband sound absorber where cavities of a plurality of resonance units with different cross sections are arranged into a cuboid, and each cavity is folded in a U-shape on a plane;

FIG. 9 is a perspective schematic diagram of a broadband sound insulator or a broadband sound absorber where cavities of a plurality of resonance units with different cross sections are arranged into a cuboid that is circular in an inner part and square in an outer part, and each cavity is folded in a U-shape on a plane;

FIG. 10 is a perspective schematic diagram of a broadband sound insulator or a broadband sound absorber where cavities of a plurality of resonance units with identical cross sections are arranged into a cuboid, and each cavity is reciprocatingly folded in a U shape in a three-dimensional space;

FIG. 11 is a schematic section view of a two-dimensional bent duct provided with a duct-outside broadband metamaterial silencer;

FIG. 12 is a perspective schematic diagram of a three-dimensional bent duct provided with a broadband metamaterial degenerate sound absorber with an opening of each resonance unit on the side wall;

FIG. 13 is a perspective schematic diagram of a broadband sound absorber outside a duct in Embodiment 1;

FIG. 14 is a planar schematic diagram of a noise-reduction layer consisting of resonance units in Embodiment 1;

FIG. 15 is a diagram showing noise-reduction effects of a broadband metamaterial silencer in Embodiment 1;

FIG. 16 is a partial planar schematic diagram of a broadband sound absorber inside a duct in Embodiment 2;

FIG. 17 is a perspective schematic diagram of a broadband sound absorber inside a duct where a straight-through air duct is formed in a ventilation duct in Embodiment 2;

FIG. 18 is an arrangement diagram of a broadband sound absorber inside a duct where a straight-through air duct is formed in a ventilation duct in Embodiment 2;

FIG. 19 is a front perspective schematic diagram of a wearable device and a broadband metamaterial silencer for a ventilation duct in Embodiment 3;

FIG. 20 is a rear perspective schematic diagram of a wearable device and a broadband metamaterial silencer for a ventilation duct in Embodiment 3;

FIG. 21 is a rear schematic diagram of an outer rigid material layer of a wearable device in Embodiment 3;

FIG. 22 is a schematic section view of a broadband metamaterial silencer of a wearable device in Embodiment 3;

FIG. 23 is a schematic section view of a broadband sound insulator in Embodiment 4;

FIG. 24 is a transmission loss spectrum diagram of a broadband sound insulator in Embodiment 4;

FIG. 25 is a perspective schematic diagram of a broadband sound insulator in Embodiment 5; and

FIG. 26 is a transmission loss spectrum diagram of a broadband sound insulator in Embodiment 5.

In the drawings, 1: ventilation duct; 2: shunted broadband metamaterial silencer inside duct; 3: broadband metamaterial silencer outside duct; 4: mesh covering material; 5: opening; 6: perforated acoustic plate; 7: cavity of a resonance unit; 8: resonance unit; 9: innermost rigid material layer; 10: outer rigid material layer; 11: broadband sound absorber arranged outside duct; 12: noise-reduction layer; 13: air duct; 901: first cavity; 902: third cavity; 903: second cavity; 904: first channel; 905: second channel; 906: inlet; 907: outlet; 908: sealing cushion; 909: Helmholtz resonator.

### DETAILED DESCRIPTION OF THE EMBODIMENTS

The present invention provides a broadband metamaterial silencer for a ventilation duct, and a design method and application thereof.

In general, a primary function of the duct is to guide airflow to circulate, such that it is desirable that silencing and noise-reduction operations do not impede the duct too much. An optimal method for achieving this requirement is to mount sound insulating/absorbing materials on side walls. For a given target broadband impedance, a plurality of resonance units can be designed accordingly to realize acoustic properties.

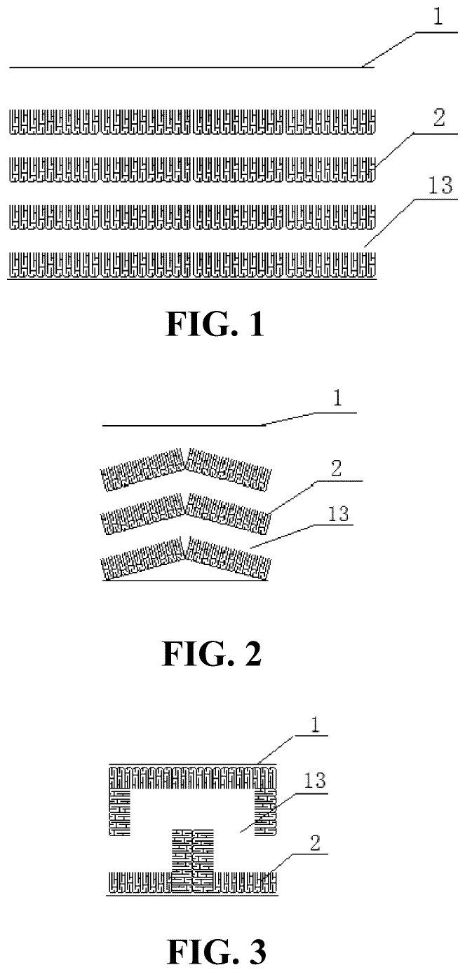

The broadband metamaterial silencer for the ventilation duct 1 is a duct-outside broadband metamaterial silencer 3, or a duct-inside shunted broadband metamaterial silencer 2, or a broadband metamaterial degenerate sound absorber;
Wherein:
The duct-outside broadband metamaterial silencer includes a broadband sound insulator arranged outside the duct, a broadband sound absorber arranged outside the duct, or a combination of the broadband sound insulator arranged outside the duct and the broadband sound absorber arranged outside the duct;
When the hole diameter of the duct is relatively large, such as in a sound insulator for an HVAC air conditioner, in addition to mounting a metamaterial on a side wall of the duct, generally, some shunted broadband metamaterial structures may also be added inside the duct, so as to increase a design space and an area of an opening of metamaterial resonance units, and effectively improve a cut-off frequency at which the silencer operates. The duct-inside shunted broadband metamaterial silencer 2 inside the duct includes a broadband sound insulator arranged inside the duct, a broadband sound absorber arranged inside the duct, or a combination of the broadband sound insulator arranged inside the duct and the broadband sound absorber arranged inside the duct; and the shunted broadband metamaterial silencer is arranged on one side or two sides inside the duct or surrounds the duct, and forms a straight-through air duct, a V-shaped air duct, or a concave-convex air duct inside the duct, as shown in FIGS. 1-3.

Whether high sound absorption can be achieved at subwavelength scales has important significance in practical applications. On the one hand, due to various limitations in many practical scenarios, there may not be a large area of the side wall of the duct available for the opening to connect a metamaterial structure. On the other hand, minimizing the area of the opening of a resonance structure can also reduce nonlinear influence on airflow. Thus, the broadband metamaterial degenerate sound absorber can be used as the silencer. The broadband metamaterial degenerate sound absorber includes a plurality of perforated acoustic plates that are perpendicular to an airflow direction in the duct, and the duct-outside broadband metamaterial silencer, or the duct-inside shunted broadband metamaterial silencer, or a combination of the duct-outside broadband metamaterial silencer and the duct-inside shunted broadband metamaterial silencer.

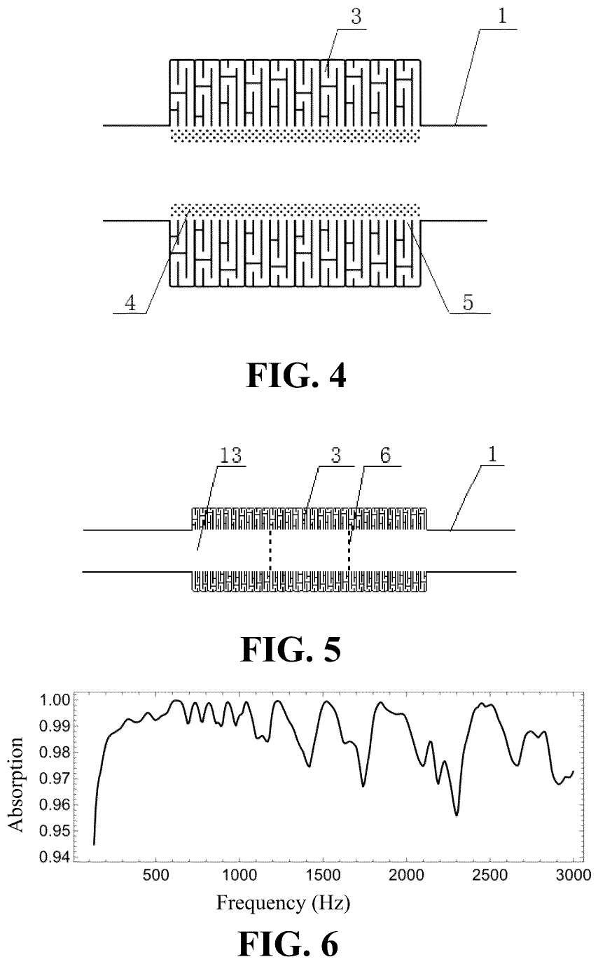

Further, for the broadband metamaterial silencer for the ventilation duct, the broadband sound insulator arranged outside the duct consists of a plurality of resonance units that are arranged in parallel and mutually independent, resonance behaviors of each resonance unit are single-frequency resonance behaviors and correspond to a specific frequency band of broadband noise to be reduced, and the resonance units achieve a sound insulating effect by reflecting sound waves at resonance frequencies and frequencies adjacent thereto (theoretically, resonance units with high quality factors achieve a sound insulating effect by reflecting sound waves at a resonance frequency; however, in practice, the resonance units generate systemic dissipation during a process of reflecting the sound waves, thereby leading to a reduction in quality factors and an increase in a resonance bandwidth; and as a result, the resonance units reflect sound waves with a certain bandwidth adjacent to the resonance frequency); each resonance unit is arranged on a side wall of the ventilation duct and provided with an opening on the duct wall of the ventilation duct, or, each resonance unit is arranged on the side wall of the ventilation duct and provided with an opening on the duct wall of the ventilation duct, wherein a mesh covering material is provided at the opening of each resonance unit;
The broadband sound absorber arranged outside the duct consists of a plurality of resonance units that are arranged in parallel and mutually independent, resonance behaviors of each resonance unit are single-frequency resonance behaviors and correspond to a specific frequency band of broadband noise to be reduced, and the resonance units achieve a sound absorbing effect by converting noise energy into heat energy and dissipating the heat energy; each resonance unit is arranged on the side wall of the ventilation duct and provided with an opening on the duct wall of the ventilation duct, or, each resonance unit is arranged on the side wall of the ventilation duct and provided with an opening on the duct wall of the ventilation duct, wherein a mesh covering material is provided at the opening of each resonance unit;
The broadband sound insulator arranged inside the duct consists of a plurality of resonance units that are arranged in parallel and mutually independent, resonance behaviors of each resonance unit are single-frequency resonance behaviors and correspond to a specific frequency band of broadband noise to be reduced, and the resonance units achieve a sound insulating effect by reflecting sound waves at resonance frequencies and frequencies adjacent thereto (theoretically, resonance units with high quality factors achieve a sound insulating effect by reflecting sound waves at a resonance frequency; however, in practice, the resonance units generate systemic dissipation during a process of reflecting the sound waves, thereby leading to a reduction in quality factors and an increase in a resonance bandwidth; and as a result, the resonance units reflect sound waves with a certain bandwidth adjacent to the resonance frequency); each resonance unit is arranged inside the ventilation duct and provided with an opening inside the ventilation duct, or, each resonance unit is arranged inside the ventilation duct and provided with an opening inside the ventilation duct, wherein a mesh covering material is provided at the opening of each resonance unit;
The broadband sound absorber arranged inside the duct consists of a plurality of resonance units that are arranged in parallel and mutually independent, resonance behaviors of each resonance unit are single-frequency resonance behaviors and correspond to a specific frequency band of broadband noise to be reduced, and the resonance units achieve a sound absorbing effect by converting noise energy into heat energy and dissipating the heat energy; each resonance unit is arranged inside the ventilation duct and provided with an opening inside the ventilation duct, or, each resonance unit is arranged inside the ventilation duct and provided with an opening inside the ventilation duct, wherein a mesh covering material is provided at the opening of each resonance unit; and
A layer of mesh covering material 4 (as shown in FIG. 4) is added at the opening 5 of each resonance unit, such as a metal mesh, sponge, woven fabric, a paper-based material, fiberglass cloth, perforated acoustic plates, and combined forms thereof. Such covering material can not only effectively alleviate a whistling problem, but also play a role in physical isolation: preventing foreign matter from entering the resonance units, which may generate additional noise or trigger safety issues; and preventing particulate matter such as dust from entering and accumulating at the outlet or inside of each resonance unit to affect the service life of the metamaterial.

For the broadband metamaterial degenerate sound absorber, each perforated acoustic plate and the duct-outside broadband metamaterial silencer and/or the duct-inside shunted broadband metamaterial silencer corresponds to a specific frequency band of the broadband noise to be reduced. FIG. 5 provides a broadband metamaterial degenerate sound absorber consisting of two perforated acoustic plates 6 and a duct-outside broadband metamaterial silencer 3, with absorption efficiency as shown in FIG. 6, which exceeds 94% in the frequency range from 130 Hz to 3000 Hz.

Further, for the broadband metamaterial silencer for the ventilation duct, each resonance unit includes a rigid housing with an opening and the air in the cavity of the rigid housing.

Further, for the broadband metamaterial silencer for the ventilation duct, each resonance unit includes, but is not limited to, Fabry-Perot resonators, Helmholtz resonators, and resonators with cavities that are in an arbitrary shape, which can isolate or absorb noise at a specific frequency band; and the acoustic effects of the resonance units are related to geometric shapes.

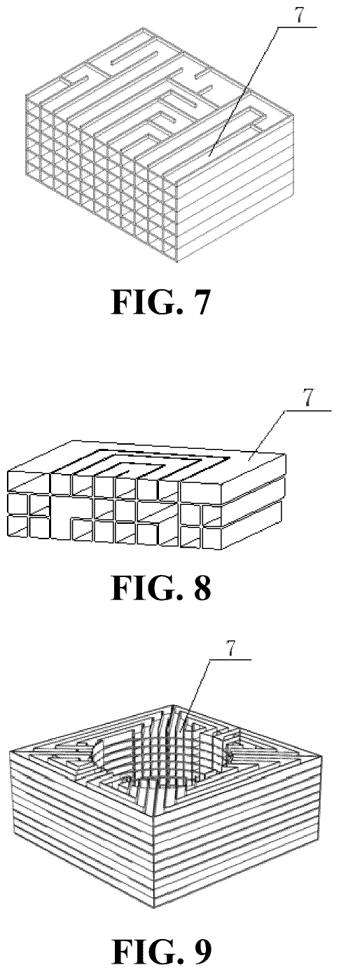

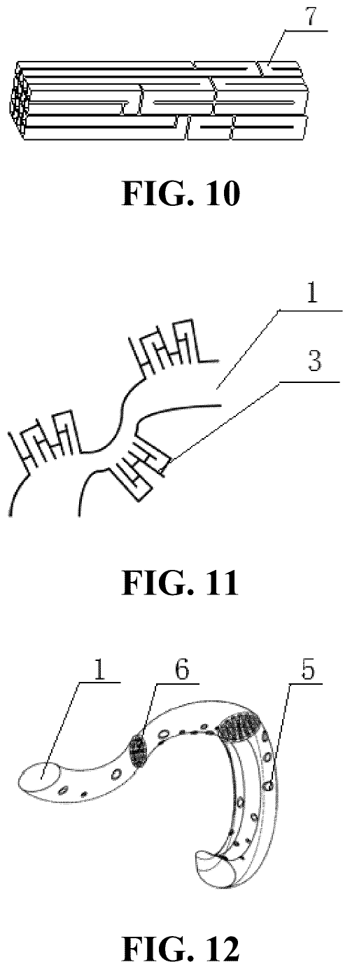

Further, for the broadband metamaterial silencer for the ventilation duct, a plurality of resonance units of the broadband sound insulator or the broadband sound absorber are arranged into geometric shapes with cavities of identical or different cross sections, and each cavity is bent and folded on a certain plane or on a curved surface (as shown in FIGS. 7-9) or in a three-dimensional space (as shown in FIG. 10). The shape of the entire broadband resonator may be either regular or irregular, and customized design can be performed according to the requirements and constraints of geometric shapes of specific application scenarios, as shown in FIGS. 7-10.

Further, for the broadband metamaterial silencer for the ventilation duct, the ventilation duct may be in an arbitrary shape, may be in a straight-through shape (as shown in FIGS. 1, 4-5), may also be in a two-dimensional bent shape (as shown in FIGS. 2, 3 and 11), in a three-dimensional bent shape (as shown in FIG. 12), etc. In a propagation direction of sound waves, the cross-sectional shape of the duct may be constant (as shown in FIG. 1) or variable (as shown in FIG. 11), and the cross-sectional dimension of the duct may range from several millimeters to dozens of centimeters. Proper bending of the duct may increase multiple scattering of the sound waves during propagation, thereby greatly enhancing the absorption capacity of resonators located on the side wall of the duct.

Further, for the broadband metamaterial silencer for the ventilation duct, the perforated acoustic plates are used for filtering impurities in air in the ventilation duct.

Introducing the perforated acoustic plates also has some potential advantages besides acoustics. For example, we can use a mesh structure to achieve a certain filtering function for particulate matter such as dust. Further, we can even use a plurality of perforated acoustic plate structures to simultaneously achieve multistage effects for acoustic filtration and matter filtration, thereby enhancing the practicality of products. FIG. 12 is taken as an example, through such a sequence of the perforated acoustic plates, the ventilation duct can be divided into different chambers, thereby helping to prevent different chambers from cross contamination to a certain extent. A ventilation system of a certain wearable device is taken as an example, a cavity of the wearable device is frequently exposed to exhaled water vapor, whereas the chamber connected to the cavity contains complex metamaterial structures and electronic systems. The perforated acoustic plates designed in the ventilation system can effectively prevent the water vapor from contaminating adjacent cavities on the basis of providing acoustic efficacy.

Further, for the broadband metamaterial silencer for the ventilation duct, the mesh covering material includes, but is not limited to, a metal mesh, sponge, woven fabric, a paper-based material, fiberglass cloth, perforated acoustic plates, and any combination of the above six materials.

Further, for the broadband metamaterial silencer for the ventilation duct, the rigid housing includes, but is not limited to, metal, plastic, wood, leather, a paper-based material, ceramic, and any combination of the above six materials.

The frequency band in which the broadband metamaterial silencer takes effect, and effects thereof are customizable. Because the operating frequency of each resonance unit can be freely adjusted through design of geometric shape, while the frequency distribution Wm of broadband resonators can also be realized by designing a plurality of resonance units with different frequencies. In principle, the impedance of any spectral profile can be realized by a series of resonance units. However, in fact, a wider effective frequency band range and better sound insulating performance both imply the need for a larger volume to design the resonators. On the other hand, many noise spectra encountered in real life often exhibit strong frequency characteristics. Therefore, designing broadband noise-reduction metamaterials with customizable spectra according to the characteristics of specific noise spectra is the most space-efficient and cost-effective solution.

Based on this, the present invention uses a second technical solution of providing a design method for the broadband metamaterial silencer for the ventilation duct, the method including the following steps:
1) Acquiring internal structural data of the ventilation duct, gas flow velocity data and gas flow rate data, as well as spectral data of noise to be reduced, containing noise intensity information;
2) According to the data acquired in step 1), optimizing the internal structure of the ventilation duct to reduce the intensity of the noise to be reduced, and then reacquiring the gas flow velocity data and the gas flow rate data, and the processed spectral data of the noise to be reduced;
3) According to the processed spectral data of the noise to be reduced and an upper limit of a design volume for the broadband metamaterial silencer, setting a target broadband impedance that maximizes reduction in the intensity of noise within a target frequency band in the ventilation duct, and then selecting a type of the broadband metamaterial silencer, as well as M resonance units or K perforated acoustic plates and L resonance units in the broadband metamaterial silencer, such that an acoustic impedance spectral profile of the M resonance units or the K perforated acoustic plates and the L resonance units is the same as that of the target broadband impedance;
Specifically,
3.1) When the broadband metamaterial silencer is a duct-outside broadband metamaterial silencer, or a duct-inside shunted broadband metamaterial silencer;
3.1.1) Fabry-Perot resonators serve as the resonance units:
For a given target broadband impedance, in order to realize the acoustic impedance spectral profile Z(ω) as a function of an angular frequency ω, designing M Fabry-Perot resonators with the same cross-sectional area; arranging the resonators in order from the longest to the shortest, and denoting the length of the m^{th} resonator as Lₘ, with a corresponding first-order resonance frequency being ωₘ=πc/(2Lₘ); according to the frequency distribution ωₘ, obtaining the number of modes Ma per unit frequency; then adjusting the length Lₘ of each resonator, such that the frequency distribution ωₘ meets the acoustic impedance spectral profile Z(ω);
Wherein a constraint therein may be expressed by the following equation (1):

$$\frac{ρ c}{2 ω} R e ( \frac{1}{Z ( ω )} ) = {\sum }_{q = 0}^{∞} \frac{\overline{{M}_{d}} [ ω / ( 2 q + 1 ) ]}{{( 2 q + 1 )}^{2}} \qquad ( 1 )$$

Wherein M̅_̅{̅d̅}̅=M_{d}φ/M, φ is the ratio of the area of openings of all resonators to the total area of sound wave incident surfaces, ρ=1.2 kg/m³ represents the air density, c=343 m/s represents the speed of sound waves in air, w is the angular frequency (in Hz), and q is an integer greater than or equal to zero;
The Fabry-Perot resonators of different lengths are folded as needed to form a compact whole for space saving, with either regular or specific geometric features;
3.1.2) Helmholtz resonators serve as the resonance units:
Denoting the area of the opening of the m^{th} resonator as aₘ, the length of the opening as [symbol] , the cross-sectional area of a cavity as Aₘ, and the length of the cavity as L, such that the resonance frequency of the m^{th} Helmholtz resonator is

$${ω}_{m} = c \sqrt{\frac{{a}_{m}}{{A}_{m} L ℓ}} ;$$

selecting aₘ/Aₘ, such that ωₘ is uniformly distributed across the frequency range; on a premise that the value of aₘ/Aₘ is maintained unchanged, adjusting Aₘ, such that impedances Zₘ of different resonators can be superposed to obtain the acoustic impedance spectral profile Z(ω):
Wherein a constraint equation (2) is:

$$\frac{1}{Z ( ω )} = {\int }_{Δ f} \frac{M / Δ f}{{Z}_{m} ( {ω}_{m} )} d {ω}_{m} \qquad ( 2 )$$

Wherein Z(ω) is in kg·m⁻²·s⁻¹;
Zₘ=i(ωₘ²−ω²)/(ωfₘ), Zₘ is in kg·m⁻²·s⁻¹; fₘ represents the resonance intensity, which is proportional to Aₘ, in m²/kg; ωₘ is in Hz; ω represents the angular frequency, in Hz;
Δf represents the target frequency band, in Hz;
M represents the total number of the Helmholtz resonators;
3.2) When the broadband metamaterial silencer is a broadband metamaterial degenerate sound absorber:
3.2.1) Design of the perforated acoustic plates

For a rigid perforated plate with a thickness of τ (in m), if circular holes therein have a hole diameter of d (in m) and a porosity of φ, corresponding dipole acoustic impedance Z_{d} is shown as equation (3):

$${Z}_{d} = - i ω {\frac{ρ τ}{2 ϕ} [ 1 - \frac{2}{σ \sqrt{i}} \frac{{J}_{1} ( σ \sqrt{i} )}{{J}_{0} ( σ \sqrt{i} )} ]}^{- 1} - i 0.85 ω \frac{ρ d}{2 ϕ} \qquad ( 3 )$$

Wherein σ=d\sqrt{ω/4ν}, ω is the broadband resonance frequency (in Hz), ρ=1.2 kg/m³ is air density, ν is kinematic viscosity of air (in m²/s), i is an imaginary unit, and J_{0/1} is the zero-order (first-order) Bessel function;
The above equation has an asymptotic expansion equation (4):

$${Z}_{d} = 16 v ρ \frac{τ}{{d}^{2} ϕ} - i \frac{51 d + 80 τ}{120 ϕ} ρω + … \qquad ( 4 )$$

When the frequency is not too high and the hole diameter and the thickness of the plate are not too large, the second term and other higher-order terms in equation (4) can be neglected, such that the acoustic impedance of the perforated plates can be approximated as a frequency-independent constant;
By designing three geometric parameters of the perforated plates, 16νρτ/(d²φ) is made to match the acoustic impedance spectral profile Z(ω);
3.2.2) Design of a broadband sound insulator, or a broadband sound absorber, or a combination of the broadband sound insulator and the broadband sound absorber

According to the method in step 3.1), obtaining the broadband sound insulator, or the broadband sound absorber, or the combination of the broadband sound insulator and the broadband sound absorber, of which the noise-reduction frequency distribution range is not greater than that of the perforated acoustic plates in step 3.2.1);
3.2.3) After the two acoustic structures are combined, obtaining the desired broadband metamaterial degenerate sound absorber;
In practical use of the broadband metamaterial silencer, if requirements for noise reduction are not extremely high, specific parameters of the perforated acoustic plates can be adjusted to a certain extent at the expense of absorption performance; on the other hand, the presence of the perforated acoustic plates in the duct will create a certain air resistance, such that in practical applications, it is necessary to perform balance and optimization based on requirements for airflow; and
4) According to the broadband metamaterial silencer designed in step 3) and the acoustic impedance spectral profile thereof, optimizing an inner wall of the duct, a structure of the broadband metamaterial silencer, and a material and/or structure of a mesh covering material again to remove noise at the target frequency.

Further, for the design method for the broadband metamaterial silencer for the ventilation duct, in step 3), the method for selecting the type of the broadband metamaterial silencer includes:
Wherein the type of the broadband metamaterial silencer is the broadband sound insulator, the broadband sound absorber and the broadband metamaterial degenerate sound absorber;

### Step I:

When reflected energy of broadband noise generates adverse effects on the environment and devices at an air inlet end of the ventilation duct, or when the reflected energy may be reflected back into the duct again, selecting the broadband sound absorber or the broadband metamaterial degenerate sound absorber; otherwise, determining all three types of absorbers are applicable;

### Step II:

When an overall dimension of the broadband metamaterial silencer in a propagation direction of sound waves is smaller than an upper limit of the wavelength of the sound waves of noise within the target frequency band, selecting the broadband sound insulator, or the broadband metamaterial degenerate sound absorber, or the combination of the broadband sound absorber and the broadband sound insulator; otherwise, determining all three types of absorbers are applicable; and

### Step III:

When the broadband metamaterial silencer is sensitive to the influence of airflow, selecting the broadband sound insulator, or the broadband sound absorber, or the combination of the broadband sound absorber and the broadband sound insulator; otherwise, determining all three types of absorbers are applicable.

The following are specific applications of the broadband metamaterial silencer and the design method based on the technical solution of the present invention.

### Embodiment 1

Application of a broadband metamaterial silencer for noise reduction in an indoor air exchange device

The indoor air exchange device is provided with a circular air outlet of which the diameter is 160 mm, noise energy is mainly concentrated in a frequency band of 250 Hz to 3000 Hz, and a prominent characteristic noise occurs at about 290 Hz. An available space of the broadband metamaterial silencer is designed in such a way that the lateral external dimension does not exceed the dimension of the device, and the internal dimension is not smaller than the dimension of the air outlet.

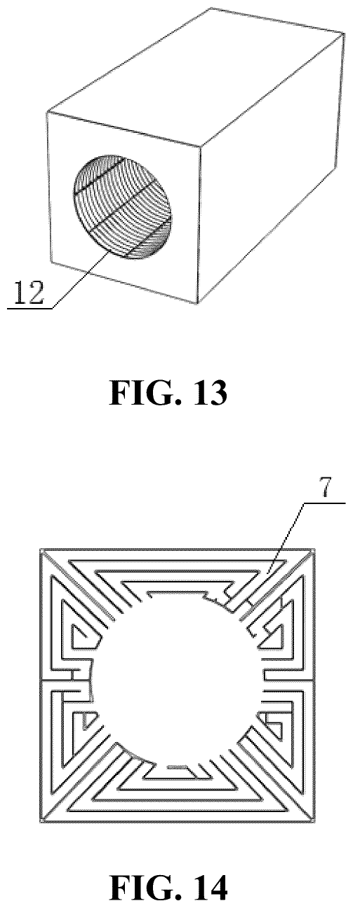

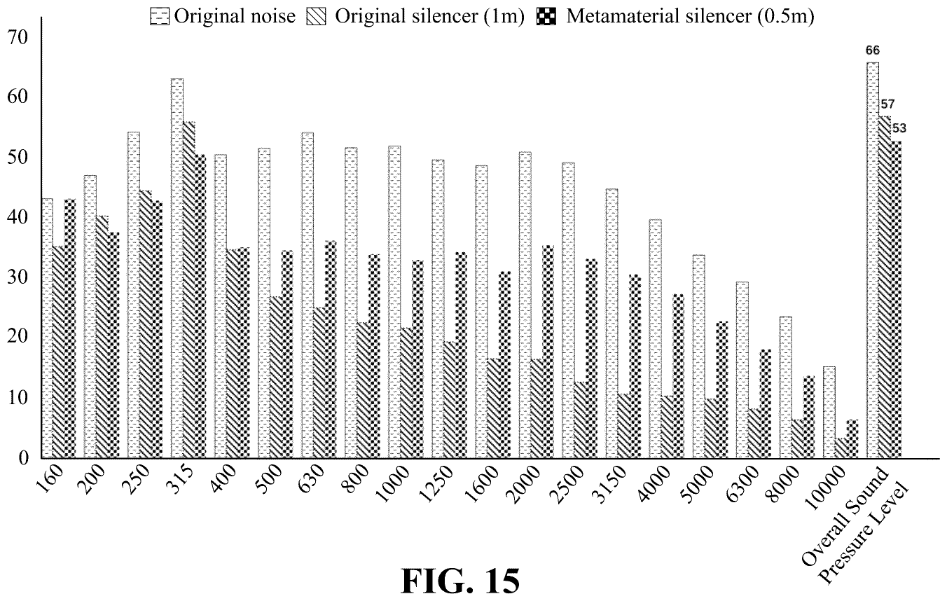

Through spectral analysis and customization, the broadband metamaterial silencer in the embodiment uses a broadband sound absorber arranged outside the duct. Resonance units of the broadband sound absorber are Fabry-Perot resonators, of which the openings are centrally designed on the side wall of an airduct of the indoor air exchange device, the dimension of each opening is 1 cm×1 cm, cavities of the resonance units are folded in a U shape on the same plane, eighteen resonance units that are arranged in parallel and mutually independent form a noise-reduction layer 12 sleeved outside the ventilation duct, and a plurality of noise-reduction layers are stacked and arrayed to form the broadband sound absorber in a shape of a duct that is circular in an inner part and square in an outer part, as shown in FIGS. 13-14, wherein an external dimension is 245 mm, an internal circular dimension is maintained to be consistent with a diameter of an original ventilation duct of the indoor air exchange device, namely 160 mm, and the ventilation flow rate reaches up to 325 m³/h. The absorption performance of the broadband sound absorber is concentrated on a critical noise frequency band, namely above 250 Hz, thereby achieving an overall noise reduction of 13 dB within a half-meter length, which is better than a noise-reduction effect of 9 dB of a conventional one-meter noise-reduction pipe (fiberglass), with the comparative results of noise-reduction effects shown in FIG. 15. The noise-reduction effect of over 26 dB can be achieved for a full length of one meter, thereby reducing a final sound power level at the air outlet to approximately 40 dBA (A-weighted decibels). The frequencies of noise reduced by the broadband sound absorber in the embodiment are 200 Hz to 8000 Hz. Moreover, the broadband sound absorber contains no porous or fibrous materials, is free of harmful substances such as dust particles that are harmful to human health, does not absorb water or generate moulds, and has a long service life, such that the broadband sound absorber is particularly suitable for application in fresh air systems closely related to human health, such as residential, office and commercial environments.

### Embodiment 2

Application of a broadband metamaterial silencer for noise reduction in a large-scale outdoor HVAC device

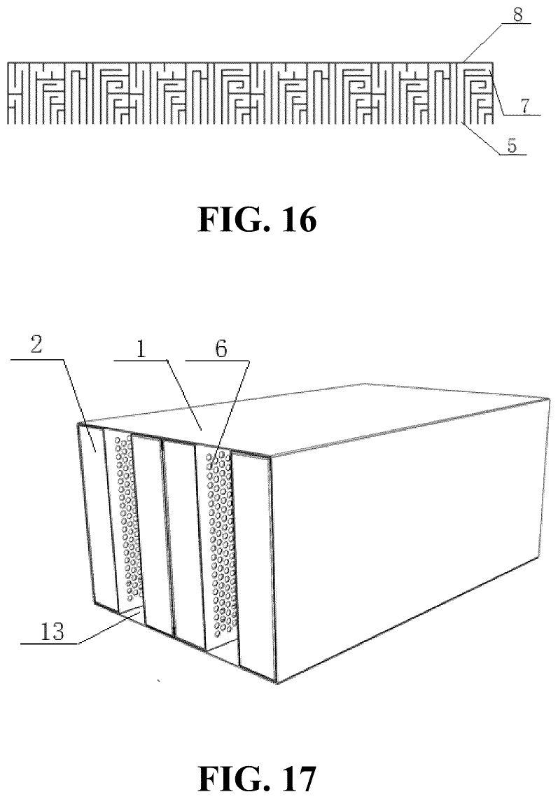

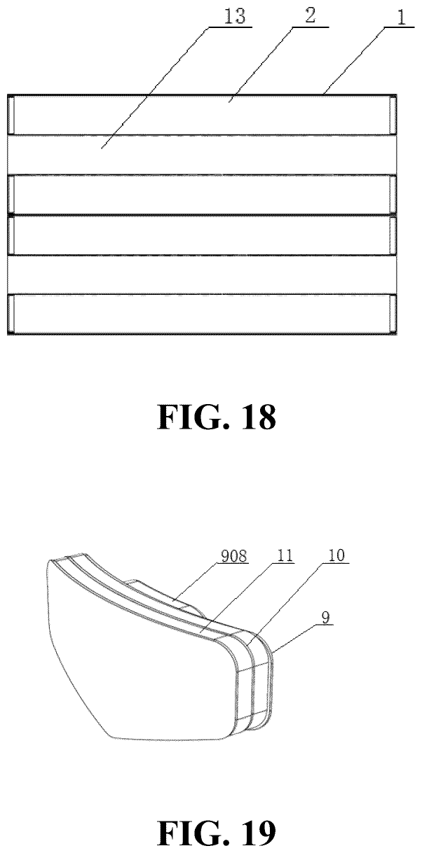

The noise of the large-scale outdoor HVAC device is from top fan units, bottom compressors and other devices, primarily covering a broad frequency band of 200 Hz to 4000 Hz, with the majority of the energy in a low-frequency range, and the whole device has high requirements for ventilation and heat dissipation. The broadband metamaterial silencer designed for such industrial noise is broadband sound absorbers arranged inside the duct, designed in the ventilation duct. Each resonance unit is a Fabry-Perot resonator, each broadband sound absorber includes thirty six resonance units with cavities reciprocatingly folded in the same plane, and the thirty six resonance units are arranged in parallel and mutually independent to form a planar shape with a thickness of 100 mm, as shown in FIG. 16, thereby realizing a single-reflection absorption coefficient exceeding 0.99 across the entire target frequency band.

The broadband sound absorbers in the embodiment can be integrally formed into various shapes, including a rectangular shape, a V shape, a concave-convex shape, a louver shape, an arrayed shape, or other shapes. Rectangular arrays are shown in FIG. 1, V-shaped arrays are shown in FIG. 2, concave-convex arrays are shown in FIG. 3, and air ducts 13 of various shapes are formed in ducts. Moreover, the broadband sound absorbers in the embodiment can be customized, according to practical applications, with different parameters such as thickness (30 cm to 200 cm) and a ventilation rate (20% to 70%), thereby forming multi-shape shunted broadband metamaterial silencers inside a duct, that can achieve better noise absorption and lower insertion loss while providing a higher ventilation rate compared to a conventional silencer. The frequencies of noise reduced by the broadband sound absorbers in the embodiment are 200 Hz to 8000 Hz.

### Embodiment 3

Application of a broadband metamaterial silencer for noise reduction in a wearable device

The application of a broadband metamaterial silencer in a wearable device of the present invention has greater advantages compared with other conventional technologies. On the one hand, the wearable device is in close contact with a human body, and thus, it is an essential requirement for the wearable device to have breathability and ventilation. But the properties of breathability and ventilation and good noise reduction/sound insulation are inherently contradictory by nature. To reduce noise in heat dissipation components such as fans in devices or prevent external noise from influencing signal acquisition inside the devices, the ventilation and noise-reduction properties of the broadband metamaterial silencer have great advantages. On the other hand, lightness is critically important for the wearable devices as well. Customizable characteristics of a broadband metamaterial silencer technology can achieve maximum acoustic performance with minimal space and the least materials, thereby effectively controlling the overall weight of the device. Finally, because the broadband metamaterial silencer of the present invention is made of materials such as plastic and silicone without traditional porous acoustic materials, the structure and the material of the broadband metamaterial silencer according to the present invention can effectively prevent it from absorbing water vapor and foreign matter in the device, and the broadband metamaterial silencer is easily detachable for direct cleaning. The property can enable the requirement for hygiene of the wearable device to be well met.

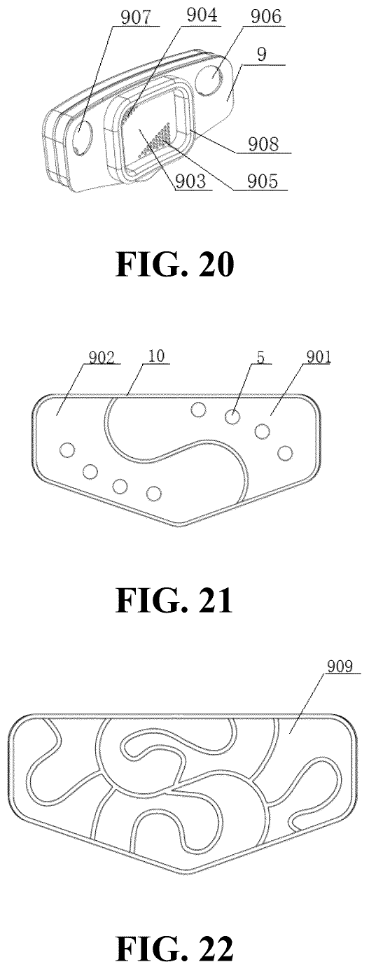

The wearable device is sensitive to the quality and volume of components, has a high demand for ventilation, and even has a need for mounting a fan to remove the water vapor generated due to human respiration and perspiration, which requires the broadband metamaterial silencer to achieve optimal noise-reduction effects under the premise of minimized volume and maximized ventilation, thus posing a significant challenge to a traditional design concept of silencers. In the present solution, as shown in FIGS. 19-22, the material of the wearable device is designed to be an outwardly protruding rigid material including two layers, namely an innermost rigid material layer 9 and an outermost rigid material layer 10, two sealed cavities are provided between the two rigid material layers, which are defined as a first cavity 901 and a third cavity 902, and a sealing cushion 908 that is in contact with the skin of a wearer is provided on an inner wall of the innermost rigid material layer, such that an inner cavity is formed between a portion of the innermost rigid material layer and the skin of the wearer, and the inner cavity is defined as a second cavity 903; a first channel 904 and a second channel 905 are provided on the innermost rigid material layer of the inner cavity; the first cavity is in communication with the second cavity through the first channel, and the second cavity is in communication with the third cavity through the second channel, such that the inner cavity, the first cavity and the third cavity jointly form the ventilation duct, an inlet 906 of the ventilation duct is provided in the innermost rigid material layer of the first cavity and located outside the inner cavity, and an outlet 907 of the ventilation duct is provided in the innermost rigid material layer of the third cavity and located outside the inner cavity; and the broadband metamaterial silencer is a broadband metamaterial degenerate sound absorber, and consists of perforated acoustic plates and broadband sound absorbers 11 arranged outside the duct, wherein the perforated acoustic plates are arranged at the first channel and the second channel, while the broadband sound absorbers arranged outside the duct are arranged on side walls of the first cavity and the third cavity, respectively. We designed Helmholtz resonators that are of a nested labyrinthine structure as resonance units for the first time. Each resonance unit is designed as a cavity that is bent and wound in a labyrinthine shape.

For the application of the broadband metamaterial silencer for noise reduction in the wearable device in the embodiment, a direction of an airflow is as follows: outside air enters the first cavity from the inlet of the ventilation duct located on one side of the first cavity, and enters the second cavity through small holes of the perforated acoustic plate provided in the first channel, the air become moist due to carrying water vapor exhaled by a human body in the second cavity, then the moist air enters the third cavity through the small holes of the perforated acoustic plate provided in the second channel, and finally is discharged through the outlet of the ventilation duct located on one side of the third cavity, and the fan can be arranged at the inlet and/or outlet to enhance air flow in the ventilation duct. The air in the entire ventilation duct, particularly the air in the second cavity, is kept dry through such airflow, while also ensuring a more comfortable wearing experience for the wearer on a hot day. It is worth mentioning that during the design process, two requirements of low air resistance and uniform airflow passing through the surface of the second cavity are considered, numerous iterative optimizations are performed by a simulation calculation method, and finally the design of the ventilation duct in the embodiment is obtained.

The noise-reduction process of the broadband metamaterial silencer in the embodiment is as follows: outside noise enters the first cavity and the third cavity from the inlet and the outlet of the ventilation duct, respectively, is further subjected to noise reduction by each resonance unit, namely a Helmholtz resonator, of the broadband sound absorber arranged outside the duct, and then is further subjected to noise reduction through the perforated acoustic plates on the first channel and the second channel, such that most of the sound wave energy is absorbed, and only a small amount of residual sound energy can enter the second cavity. Herein, for the broadband sound absorber arranged outside the duct, according to a design concept of the broadband metamaterial silencer mentioned above and spectral characteristics of human auditory sensitivity, a plurality of Helmholtz resonators 909 that are mutually independent are designed on the outer sides of the first cavity and the third cavity, each resonance unit (Helmholtz resonator) is folded into a labyrinth shape, and the resonance units are respectively in communication with the first cavity or the third cavity through openings 5 with different areas (ranging from 3.4 mm² to 5.7 mm²), as shown in FIGS. 21 and 22. Because the openings have small areas, it is difficult for the airflow and the water vapor to enter the resonators through the openings. However, sound can easily enter the resonators under the action of resonance behaviors and can be absorbed. Therefore, the broadband metamaterial silencer that is of a nested labyrinth structure can continuously absorb noise transmitted from the first cavity, the second cavity and the third cavity without affecting airflow. As a result, effective noise reduction is achieved while ensuring sufficient ventilation.

According to the standard of ISO 717-1 2013, we tested insertion loss of broadband metamaterial silencers (ten samples) in the embodiment in an anechoic chamber of 3 m×3 m×3 m. Test results show that in a designed frequency band of the silencers, namely at a frequency range from 800 Hz to 8000 Hz, the insertion loss of the component is much higher than that of a control test group in the same shape but without metamaterials. The equivalent insertion loss of the component is 25.3±0.3 dBA under white noise test and 21.6±0.3 dBA under human voice test. The test results of the control group without metamaterial structure design under the same conditions are 17.4 dBA (white noise) and 10.3 dBA (human voice), respectively.

We also tested the ventilation performance of the duct design of the component, and the test results show that the ventilation system can remove moisture effectively. If described in terms of relative humidity, namely

$$RH ( t ) = {RH}_{0} + ( 100 \% - {RH}_{0} ) {e}^{- \frac{t - {t}_{0}}{a}} ,$$

wherein RH₀ is ambient relative humidity and t₀ is fan operation time, a measured average lifetime factor for single-cycle water vapor removal is a=44.3±4.1 seconds.

### Embodiment 4

Application of a broadband metamaterial silencer for noise reduction in a water heater fan

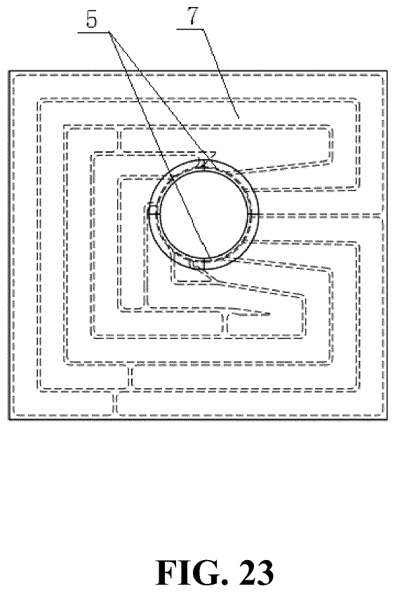

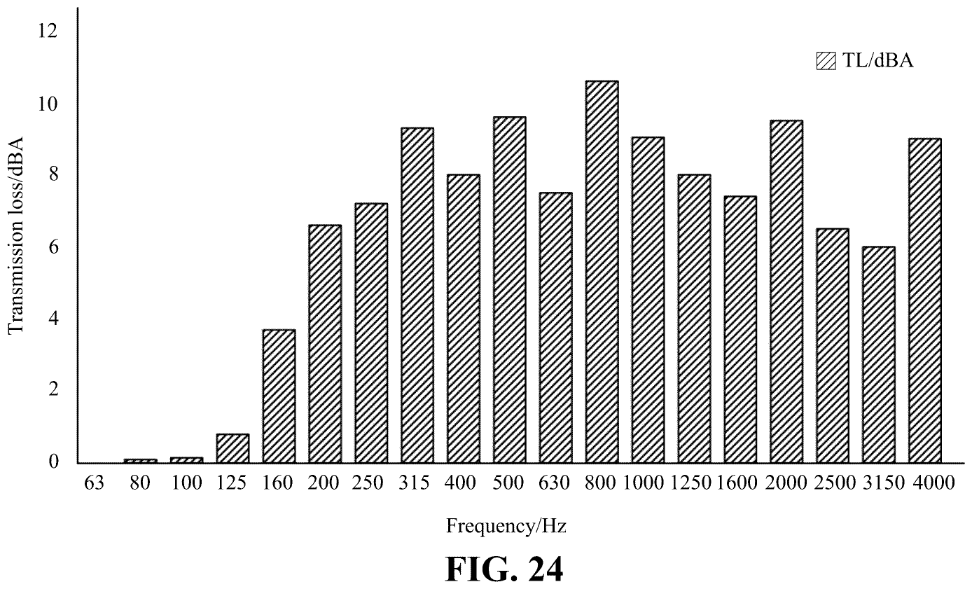

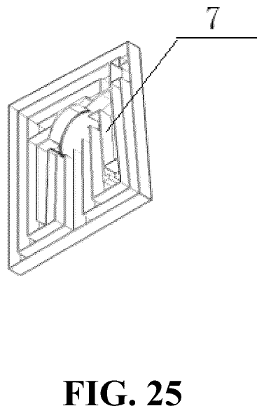

The noise of a gas water heater is mainly from a small centrifugal fan inside a compartment of the water heater. An air outlet of the fan is connected to the outside through an exhaust duct, while an air duct of an air inlet is exposed on a rear panel of the water heater. Usually, air is supplied to the fan through an opening in the rear panel, such that the air duct becomes a main source of fan noise transmitted into a room. Main noise energy covers a frequency range of 200 Hz to 3000 Hz, and an internal space is very compact. Through spatial analysis and spectral analysis, a corresponding broadband metamaterial silencer is designed at the air inlet of the fan. The design requires that the air inlet of the broadband metamaterial silencer has the same diameter as the original air inlet, thereby reducing an impact on ventilation efficiency. Moreover, the overall structure should be kept within the original lateral area of the fan without causing interference to other original structures. The broadband metamaterial silencer used in the embodiment is a broadband sound insulator outside the duct. As shown in FIG. 23, resonance units of the broadband sound insulator are Fabry-Perot resonators, and cavities of the resonance units are reciprocatingly folded on the same plane. Ten resonance units, which are arranged in parallel and mutually independent, form a broadband sound insulator sleeved outside the duct. The opening of each resonance unit is of a rectangular structure with dimensions of 10 mm×20 mm and is located on the side wall of the duct. An overall thickness of the broadband sound insulator is 22 mm, covering a critical noise frequency band, and forming a broadband sound insulator in a frequency range of 200 Hz to 4000 Hz, and achieving a noise-reduction effect of approximately 8 dB on a single centrifugal fan, as shown in FIG. 24.

### Embodiment 5

Application of a broadband metamaterial silencer in a ventilation duct of a device power component (including, but not limited to, a pump, a compressor, a motor, etc.)

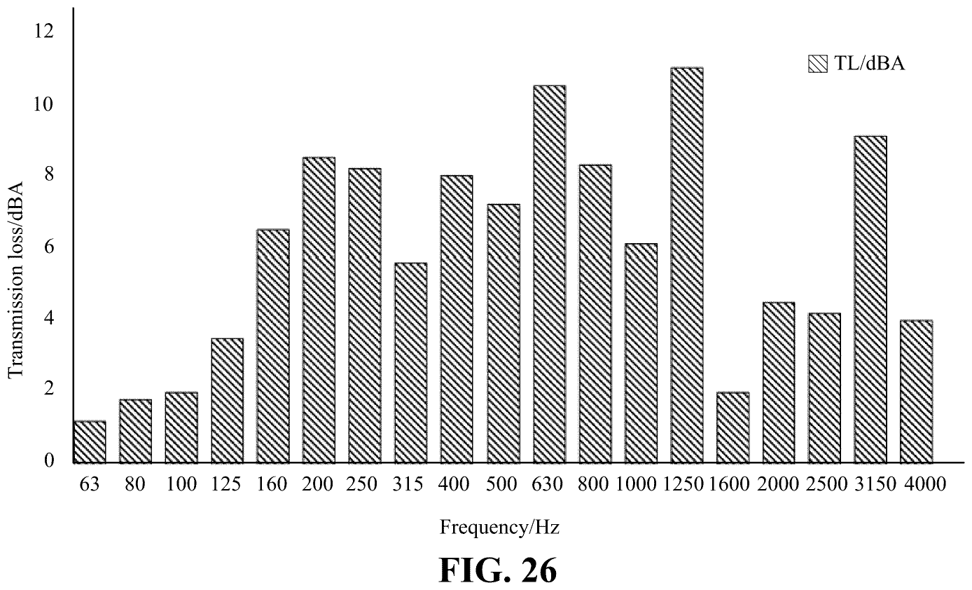

Under standard conditions, power components of some devices (including, but not limited to a pump, a compressor, a motor, etc.) exhibit significant noise issues. Due to requirements for heat dissipation, the power components cannot be completely enclosed, which enables the power components to be a primary source of noise propagated indoors. Therefore, there is a need for effective noise reduction while maintaining ventilation. Traditional porous materials cannot achieve efficient noise reduction for low frequencies under limited spaces and are prone to absorbing water and becoming moist, thus failing to serve as an effective noise-reduction means. In the embodiment, the broadband metamaterial silencer is designed as a duct-outside broadband metamaterial silencer, which is mounted at the position of a ventilation duct at an outlet of a compartment for the device power component, while maintaining a diameter of the air outlet unchanged. The duct-outside broadband metamaterial silencer is a broadband sound insulator, as shown in FIG. 25, resonance units of the broadband sound insulator are Fabry-Perot resonators, and cavities of the resonance units are reciprocatingly folded on the same plane. Ten resonance units, which are arranged in parallel and mutually independent, form a broadband sound insulator sleeved outside the duct. Each resonance unit is a rectangular cavity with a diameter of 9 mm×22 mm, and an opening is located on the side wall of a circular air outlet duct for the compartment of the power component with a diameter of 41 mm. An overall thickness of the broadband sound insulator is approximately 24 mm, and a lateral structure is in an irregular quadrilateral. The broadband sound insulator covers a main broadband noise frequency range from 160 Hz, with a noise-reduction frequency range of 160 Hz to 4000 Hz and an average transmission loss exceeding 6 dB, as shown in FIG. 26. Moreover, based on the properties of a pure structural absorption and noise reduction principle, the broadband sound insulator is not affected by factors such as humidity and dust, and can maintain stable noise-reduction performance for a long time

1. A broadband metamaterial silencer for a ventilation duct, wherein the broadband metamaterial silencer is a duct-outside broadband metamaterial silencer, or a duct-inside shunted broadband metamaterial silencer, or a broadband metamaterial degenerate sound absorber;
the duct-outside broadband metamaterial silencer comprises a broadband sound insulator arranged outside the duct, a broadband sound absorber arranged outside the duct, or a combination of the broadband sound insulator arranged outside the duct and the broadband sound absorber arranged outside the duct;
the duct-inside shunted broadband metamaterial silencer comprises a broadband sound insulator arranged inside the duct, a broadband sound absorber arranged inside the duct, or a combination of the broadband sound insulator arranged inside the duct and the broadband sound absorber arranged inside the duct; and
the broadband metamaterial degenerate sound absorber comprises a plurality of perforated acoustic plates that are perpendicular to an airflow direction in the duct, and the duct-outside broadband metamaterial silencer, or the duct-inside shunted broadband metamaterial silencer, or a combination of the duct-outside broadband metamaterial silencer and the duct-inside shunted broadband metamaterial silencer;
wherein the broadband sound insulator arranged outside the duct consists of a plurality of resonance units that are arranged in parallel and mutually independent, resonance behaviors of each resonance unit are single-frequency resonance behaviors and correspond to a specific frequency band of broadband noise to be reduced, and the resonance units achieve a sound insulating effect by reflecting sound waves at resonance frequencies and frequencies adjacent thereto; each resonance unit is arranged on a side wall of the ventilation duct and provided with an opening on the duct wall of the ventilation duct, or, each resonance unit is arranged on the side wall of the ventilation duct and provided with an opening on the duct wall of the ventilation duct, wherein a mesh covering material is provided at the opening of each resonance unit;
the broadband sound absorber arranged outside the duct consists of a plurality of resonance units that are arranged in parallel and mutually independent, resonance behaviors of each resonance unit are single-frequency resonance behaviors and correspond to a specific frequency band of broadband noise to be reduced, and the resonance units achieve a sound absorbing effect by converting noise energy into heat energy and dissipating the heat energy;
each resonance unit is arranged on the side wall of the ventilation duct and provided with an opening on the duct wall of the ventilation duct, or, each resonance unit is arranged on the side wall of the ventilation duct and provided with an opening on the duct wall of the ventilation duct, wherein a mesh covering material is provided at the opening of each resonance unit;
the broadband sound insulator arranged inside the duct consists of a plurality of resonance units that are arranged in parallel and mutually independent, resonance behaviors of each resonance unit are single-frequency resonance behaviors and correspond to a specific frequency band of broadband noise to be reduced, and the resonance units achieve a sound insulating effect by reflecting sound waves at resonance frequencies and frequencies adjacent thereto; each resonance unit is arranged inside the ventilation duct and provided with an opening inside the ventilation duct, or, each resonance unit is arranged inside the ventilation duct and provided with an opening inside the ventilation duct, wherein a mesh covering material is provided at the opening of each resonance unit;
the broadband sound absorber arranged inside the duct consists of a plurality of resonance units that are arranged in parallel and mutually independent, resonance behaviors of each resonance unit are single-frequency resonance behaviors and correspond to a specific frequency band of broadband noise to be reduced, and the resonance units achieve a sound absorbing effect by converting noise energy into heat energy and dissipating the heat energy;
each resonance unit is arranged inside the ventilation duct and provided with an opening inside the ventilation duct, or, each resonance unit is arranged inside the ventilation duct and provided with an opening inside the ventilation duct, wherein a mesh covering material is provided at the opening of each resonance unit; and
for the broadband metamaterial degenerate sound absorber, each perforated acoustic plate and the duct-outside broadband metamaterial silencer and/or the duct-inside shunted broadband metamaterial silencer corresponds to a specific frequency band of the broadband noise to be reduced;
wherein each resonance unit comprises a rigid housing with an opening and the air in a cavity of the rigid housing; and
the plurality of resonance units are arranged into geometric shapes with cavities of identical or different cross-sections, and each cavity is bent and folded on a certain plane, or on a curved surface, or in a three-dimensional space.

2. (canceled)

3. (canceled)

4. The broadband metamaterial silencer for the ventilation duct according to claim 1, wherein each resonance unit comprises Fabry-Perot resonators, Helmholtz resonators, and resonators with cavities that are in an arbitrary shape, which isolates or absorbs noise at a specific frequency band.

5. (canceled)

6. The broadband metamaterial silencer for the ventilation duct according to claim 1, wherein the perforated acoustic plates are used for filtering impurities in air in the ventilation duct.

7. The broadband metamaterial silencer for the ventilation duct according to claim 1, wherein the mesh covering material comprises a metal mesh, sponge, woven fabric, a paper-based material, fiberglass cloth, perforated acoustic plates, and any combination of the above six materials.

8. The broadband metamaterial silencer for the ventilation duct according to claim 1, wherein the materials of the broadband metamaterial silencer comprise metal, plastic, wood, leather, a paper-based material, ceramic, and any combination of the above six materials.

9. The broadband metamaterial silencer for the ventilation duct according to claim 1, wherein the ventilation duct is in an arbitrary shape, comprising a straight-through shape, a bent shape, and constant or variable cross-sectional shapes.

10. A design method for a broadband metamaterial silencer for a ventilation duct, comprising the following steps:
1) acquiring internal structural data of the ventilation duct, gas flow velocity data and gas flow rate data, as well as spectral data of noise to be reduced, containing noise intensity information;
2) according to the data acquired in step 1), optimizing an internal structure of the ventilation duct to reduce an intensity of the noise to be reduced, and then reacquiring the gas flow velocity data and the gas flow rate data, and the processed spectral data of the noise to be reduced;
3) according to the processed spectral data of the noise to be reduced and an upper limit of a design volume for the broadband metamaterial silencer, setting a target broadband impedance that maximizes reduction in the intensity of noise within a target frequency band in the ventilation duct, and then selecting a type of the broadband metamaterial silencer, as well as M resonance units or K perforated acoustic plates and L resonance units in the broadband metamaterial silencer, such that an acoustic impedance spectral profile of the M resonance units or the K perforated acoustic plates and the L resonance units is the same as that of the target broadband impedance;
specifically,
3.1) when the broadband metamaterial silencer is a duct-outside broadband metamaterial silencer, or a duct-inside shunted broadband metamaterial silencer;
3.1.1) Fabry-Perot resonators serve as the resonance units:
for a given target broadband impedance, in order to realize the acoustic impedance spectral profile Z(ω) as a function of an angular frequency ω, designing M Fabry-Perot resonators with the same cross-sectional area; arranging the resonators in order from the longest to the shortest, and denoting a length of the n^{th} resonator as Lₘ, with a corresponding first-order resonance frequency being ωₘπc/(2Lₘ); according to the frequency distribution ωₘ, obtaining the number of modes M_{d} per unit frequency; then adjusting the length Lₘ of each resonator, such that the frequency distribution ωₘ meets the acoustic impedance spectral profile Z(ω);
wherein a constraint therein is expressed by the following equation (1):
$$\frac{ρ c}{2 ω} R e ( \frac{1}{Z ( ω )} ) = {\sum }_{q = 0}^{∞} \frac{\overline{{M}_{d}} [ ω / ( 2 q + 1 ) ]}{{( 2 q + 1 )}^{2}} \qquad ( 1 )$$
wherein M̅_̅{̅d̅}̅=M_{d}φ/M, φ is a ratio of an area of openings of all resonators to a total area of sound wave incident surfaces, ρ=1.2 kg/m² represents the air density, c=343 m/s represents the speed of sound waves in air, ω is the angular frequency (in Hz), and q is an integer greater than or equal to zero;
3.1.2) Helmholtz resonators serve as the resonance units:
denoting an area of the opening of the m^{th} resonator as aₘ, a length of the opening as [symbol] , a cross-sectional area of the cavity as Aₘ, and a length of the cavity as L, such that a resonance frequency of the m^{th} Helmholtz resonator is
$${ω}_{m} = c \sqrt{\frac{{a}_{m}}{{A}_{m} L ℓ}} ;$$
selecting aₘ/Aₘ, such that ωₘ is uniformly distributed across the frequency range; on a premise that a value of aₘ/Aₘ is maintained unchanged, adjusting Aₘ, such that impedances Zₘ of different resonators are capable of being superposed to obtain the acoustic impedance spectral profile Z(ω):
wherein a constraint equation (2) is:
$$\frac{1}{Z ( ω )} = {\int }_{Δ f} \frac{M / Δ f}{{Z}_{m} ( {ω}_{m} )} d {ω}_{m} \qquad ( 2 )$$
wherein Z(ω) is in kg·m⁻²·s⁻¹;
Zₘ=t(ωₘ²−ω²)/(ωfₘ), Zₘ is in kg·m⁻²·s⁻¹; fₘ represents a resonance intensity, which is proportional to Aₘ, in m²/kg; ωₘ is in Hz; ω represents the angular frequency, in Hz;
Δf represents a target frequency band, in Hz;
M represents a total number of the Helmholtz resonators;
3.2) when the broadband metamaterial silencer is a broadband metamaterial degenerate sound absorber:
3.2.1) design of the perforated acoustic plates
for a rigid perforated plate with a thickness of τ, if circular holes therein have a hole diameter of d, and a porosity of φ, ρ is air density and ν is kinematic viscosity of air, designing three geometric parameters of the perforated plate, such that 16νρτ/(d²φ) is the same as the acoustic impedance spectral profile Z(ω);
wherein τ and d are in m, ρ=1.2 kg/m², and ν is in m²/s;
3.2.2) design of a broadband sound insulator, or a broadband sound absorber, or a combination of the broadband sound insulator and the broadband sound absorber
according to the method in step 3.1), obtaining the broadband sound insulator, or the broadband sound absorber, or the combination of the broadband sound insulator and the broadband sound absorber, of which a frequency range of the acoustic impedance spectral profile is not greater than that of the acoustic impedance spectral profile of the perforated acoustic plates in step 3.2.1);
3.2.3) after the two acoustic structures are combined, obtaining the desired broadband metamaterial degenerate sound absorber; and
4) according to the broadband metamaterial silencer designed in step 3) and the acoustic impedance spectral profile thereof, optimizing an inner wall of the duct, a structure of the broadband metamaterial silencer, and a material and/or structure of a mesh covering material again to remove noise at a target frequency.

11. The design method for the broadband metamaterial silencer for the ventilation duct according to claim 10, wherein in step 3), a method for selecting the type of the broadband metamaterial silencer comprises:
Step I:
when reflected energy of broadband noise generates adverse effects on the environment and devices at an air inlet end of the ventilation duct, or when the reflected energy is reflected back into the duct again, selecting the broadband sound absorber or the broadband metamaterial degenerate sound absorber; otherwise, determining all three types of absorbers are applicable;
Step II:
when an overall dimension of the broadband metamaterial silencer in a propagation direction of sound waves is smaller than an upper limit of a wavelength of the sound waves of noise within the target frequency band, selecting the broadband sound insulator, or the broadband metamaterial degenerate sound absorber, or the combination of the broadband sound absorber and the broadband sound insulator; otherwise, determining all three types of absorbers are applicable; and
Step III:
when the broadband metamaterial silencer is sensitive to the influence of airflow, selecting the broadband sound insulator, or the broadband sound absorber, or the combination of the broadband sound absorber and the broadband sound insulator; otherwise, determining all three types of absorbers are applicable.

12. Application of a broadband metamaterial silencer for a ventilation duct, wherein the broadband metamaterial silencer is used for noise reduction of a wearable device, wherein
a material of the wearable device is designed to be an outwardly protruding rigid material comprising two or more layers, a plurality of sealed cavities are provided between adjacent rigid material layers, and a sealed inner cavity is formed between an innermost rigid material layer or a portion thereof and a skin of a wearer; the inner cavity is in communication with other sealed cavities through channels in the rigid material layers, such that the inner cavity and the other cavities jointly form the ventilation duct, an inlet of the ventilation duct is formed in the innermost rigid material layer or an outermost rigid material layer, and an outlet of the ventilation duct is formed in the innermost rigid material layer or the outermost rigid material layer; and the broadband metamaterial silencer is a broadband metamaterial degenerate sound absorber.

13. The application of the broadband metamaterial silencer for the ventilation duct according to claim 12, wherein the material of the wearable device is designed to be the outwardly protruding rigid material comprising two layers, which are the innermost rigid material layer and the outermost rigid material layer, two sealed cavities defined as a first cavity and a third cavity are provided between the two rigid material layers, and a sealing cushion that is in contact with the skin of the wearer is provided on an inner wall of the innermost rigid material layer, such that the inner cavity is formed between a portion of the innermost rigid material layer and the skin of the wearer, and the inner cavity is defined as a second cavity; a first channel and a second channel are provided on the innermost rigid material layer of the inner cavity; the first cavity is in communication with the second cavity through the first channel, and the second cavity is in communication with the third cavity through the second channel, such that the inner cavity, the first cavity and the third cavity jointly form the ventilation duct, the inlet of the ventilation duct is provided in the innermost rigid material layer of the first cavity and located outside the inner cavity, and the outlet of the ventilation duct is provided in the innermost rigid material layer of the third cavity and located outside the inner cavity; and the broadband metamaterial silencer is the broadband metamaterial degenerate sound absorber, and consists of perforated acoustic plates and a broadband sound absorber arranged outside the duct, wherein the perforated acoustic plates are arranged at the first channel and the second channel, while the broadband sound absorber arranged outside the duct is arranged on side walls of the first cavity and the third cavity, respectively.

14. The application of the broadband metamaterial silencer for the ventilation duct according to claim 12, wherein a fan is provided at the inlet and/or the outlet of the ventilation duct.

15. The application of the broadband metamaterial silencer for the ventilation duct according to claim 12, wherein a frequency range of noise reduced by the broadband metamaterial degenerate sound absorber is 800 Hz to 8000 Hz.

16. The application of the broadband metamaterial silencer for the ventilation duct according to claim 13, wherein resonance units of the broadband sound absorber arranged outside the duct are Helmholtz resonators, and cavities of the Helmholtz resonators are reciprocatingly folded into a labyrinthine shape; and the plurality of Helmholtz resonators are provided, some of the Helmholtz resonators are provided with openings on a side wall of the first cavity, and other Helmholtz resonators are provided with openings on a side wall of the third cavity.

17. Application of the broadband metamaterial silencer for the ventilation duct according to claim 1, wherein the broadband metamaterial silencer is used for noise reduction in the ventilation duct of an indoor air exchange device, wherein
a broadband sound absorber arranged outside the duct is mounted on a side wall of the ventilation duct at an air outlet of the indoor air exchange device, resonance units of the broadband sound absorber are Fabry-Perot resonators, cavities of the resonance units are reciprocatingly folded on a same plane, the plurality of resonance units that are arranged in parallel and mutually independent form a noise-reduction layer sleeved outside the ventilation duct, each resonance unit in the noise-reduction layer is provided with an opening on the side wall of the ventilation duct, and the plurality of noise-reduction layers are stacked to form the broadband sound absorber; and
a frequency range of noise reduced by the broadband sound absorber is 200 Hz to 8000 Hz.

18. Application of the broadband metamaterial silencer for the ventilation duct according to claim 1, wherein the broadband metamaterial silencer is used for noise reduction in a ventilation duct of an outdoor heating, ventilation, and air conditioning (HVAC) device, wherein
a broadband sound absorber arranged inside the duct is mounted inside the ventilation duct of the outdoor HVAC device, resonance units of the broadband sound absorber are Fabry-Perot resonators, cavities of the resonance units are reciprocatingly folded on a same plane, the plurality of resonance units that are arranged in parallel and mutually independent form the broadband sound absorber that is rectangular, V-shaped, concave-convex, louver-shaped, or array-shaped, and each resonance unit is provided with an opening in the ventilation duct; and
a frequency range of noise reduced by the broadband sound absorber is 200 Hz to 8000 Hz.

19. Application of the broadband metamaterial silencer for the ventilation duct according to claim 1, wherein the broadband metamaterial silencer is used for noise reduction in a ventilation duct of a gas water heater, wherein
a broadband sound insulator arranged outside the duct is mounted on a side wall of the ventilation duct at an inlet of a centrifugal fan of the gas water heater, resonance units of the broadband sound insulator are Fabry-Perot resonators, cavities of the resonance units are reciprocatingly folded on a same plane, the plurality of resonance units that are arranged in parallel and mutually independent form the broadband sound insulator sleeved outside the duct, and each resonance unit is provided with an opening on the side wall of the ventilation duct; and
a frequency of noise reduced by the broadband sound insulator is 200 Hz to 4000 Hz.

20. Application of the broadband metamaterial silencer for the ventilation duct according to claim 1, wherein the broadband metamaterial silencer is used for noise reduction in a ventilation duct of a device power component, wherein
a broadband sound insulator arranged outside the duct is mounted on a side wall of the ventilation duct at an outlet and/or inlet of the ventilation duct of a compartment of the device power component, resonance units of the broadband sound insulator are Fabry-Perot resonators, cavities of the resonance units are reciprocatingly folded on a same plane, the plurality of resonance units that are arranged in parallel and mutually independent form the broadband sound insulator sleeved outside the duct, and each resonance unit is provided with an opening on the side wall of the ventilation duct; and
a frequency range of noise reduced by the broadband sound insulator is 160 Hz to 4000 Hz.
